(19) United States
(12) Patent Application Publication
(10) Pub. No.: US 2026/0056712 A1
(43) Pub. Date: Feb. 26, 2026

(54) CRITICAL PATH AND INTERMEDIATE NODE IDENTIFICATION METHOD FOR HIDDEN WATER SCARCITY RISK TRANSMISSION BASED ON BETWEENNESS CENTRALITY ALGORITHM

(71) Applicant: Beijing Normal University, Beijing (CN)

(72) Inventors: Hui LI, Beijing (CN); Hanlei WANG, Beijing (CN); Yulei XIE, Beijing (CN); Gengyuan LIU, Beijing (CN); Zhifeng YANG, Beijing (CN)

(73) Assignee: Beijing Normal University, Beijing (CN)

(21) Appl. No.: 19/376,923

(22) Filed: Nov. 1, 2025

(30) Foreign Application Priority Data
Dec. 18, 2024 (CN) 202411871688.0

(51) Int. Cl. G06F 7/544; G06N 7/01

(52) U.S. Cl. CPC G06F 7/544; G06N 7/01

(57) ABSTRACT

The present disclosure discloses a method of reducing regional water scarcity risk. The method includes obtaining the water scarcity probability of each region, and obtaining the water scarcity risk of each sector in each region calculated based on the water resource dependence of each sector in each region and combining the water scarcity probability of each region; according to the water scarcity risk of each sector and based on a multi-regional input-output model, constructing a hidden water scarcity risk transfer matrix; based on the structural path analysis and the hidden water scarcity risk transfer matrix, identifying the critical transmission path of the hidden water scarcity risk, and constructing a hidden water scarcity risk transmission network; identifying a critical intermediate node in the hidden water scarcity risk transmission network based on the betweenness centrality algorithm

### TECHNICAL FIELD

The present disclosure relates to the field of water resources management, especially a critical path and intermediate node identification method of a hidden water scarcity risk transmission based on a betweenness centrality algorithm.

### BACKGROUND

Against the backdrop of global climate change and population growth, the scarcity of water resources is becoming increasingly severe, posing a major constraint to sustainable socioeconomic development. Given the high interconnectivity of trade networks, regional water scarcity not only causes direct economic losses in local water-intensive sectors such as agriculture and power generation but may also propagate risks to other regions through supply chains, triggering cascading effects. This type of risk, transmitted via trade linkages, can be defined as a hidden water scarcity risk. Identifying the critical pathways and intermediate nodes through which hidden water scarcity risk propagates is essential for enhancing the resilience of trade networks.

Conventional research has largely focused on water scarcity within specific geographical boundaries, paying limited attention to the cross-regional transmission mechanisms of implicit water risk. While some studies have identified source—sink relationships in the propagation of implicit water scarcity, the intermediate transmission pathways and pivotal nodes remain inadequately characterized. In the process of risk transmission, numerous critical intermediate nodes act as “bridges,” channeling substantial amounts of hidden water scarcity risk throughout the trade network. Identifying these critical intermediary nodes enables timely interventions before risks spread to downstream sectors. To address this gap, this study introduces a betweenness centrality algorithm based on structural path analysis (SPA) to effectively identify critical transmission paths and critical intermediary nodes of water scarcity risk within trade networks, thereby providing a scientific basis for formulating targeted risk prevention and control strategies.

### SUMMARY

In order to solve the above problems, this disclosure proposes a critical path and intermediate node identification method of a hidden water scarcity risk transmission based on a betweenness centrality algorithm, including the following steps: S1, obtaining a water scarcity probability of each region, and obtaining a water scarcity risk of each sector in each region calculated based on a water resource dependence of each sector in each region and combining the water scarcity probability of each region;

S2, according to the water scarcity risk of each sector and based on a multi-regional input-output model, constructing a hidden water scarcity risk transfer matrix;

S3, based on a structural path analysis (SPA) and the hidden water scarcity risk transfer matrix, identifying a critical transmission path of the hidden water scarcity risk, and constructing a hidden water scarcity risk transmission network;

S4, identifying a critical intermediate node in the hidden water scarcity risk transmission network based on a betweenness centrality algorithm Betweenness.

In some embodiments, the expression of water scarcity probability in each region is as follows:

$${WSP}_{i} = exp ( {μ}_{{w}_{i}} + \frac{{σ}^{2}}{2} ) ;$$

$${w}_{i} ∼ ( {μ}_{{w}_{i}} , {σ}^{2} ) ;$$

where WSPᵢ denotes a water scarcity probability of a region i is equal to an expected value of a random variable wᵢ; the random variable wᵢ obeys the lognormal distribution, the variance is

$${μ}_{i} = log \frac{1}{{WSI}_{i}} ,$$

σ denotes a standard deviation and is equal to 1;

$${WSI}_{i} = \frac{{WC}_{i}}{{Q}_{i}} ,$$

WSIᵢ denotes a water pressure index of the region i, WCᵢ denotes the water consumption of the region i, and Qᵢ denotes an available freshwater volume of the region i.

In some embodiments, the expression of water resource dependence of each sector in each region is as follows:

$${WD}_{m , i} = {f}_{WD} ( {WI}_{m , i} ; α ) = \frac{1}{1 + {e}^{- α {WI}_{m , i}^{i n t}} ( \frac{1}{0.001} - 1 )} ;$$

$${WI}_{m , i} = \frac{{WC}_{m , i}}{{x}_{m , i}} ;$$

where WD_{m,i} denotes a water resource dependence of a sector m in the region i; WC_{m,i} denotes the amount of water used by the sector m in the region i; WI_{m,i} denotes a water intensity of the sector m in the region i, it equals the water consumption WC_{m,i} of the sector in the region divided by its total output x_{m,i}; α is the truncation parameter, which is set to 0.5.

In some embodiments, the expression of water scarcity risk of each sector in each region is as follows:

$${WSR}_{m , i} = {WSP}_{i} \times {WD}_{m , i} \times {x}_{m , i} ;$$

where WSR_{m,i} denotes a water scarcity risk in the sector m in the region i; WSPᵢ denotes a probability of water scarcity in the region i; WD_{m,i} denotes a water resource dependence of the sector m in the region i; x_{m,i} denotes a total output of the sector n in the region j.

In some embodiments, the expression of the hidden water scarcity risk transfer matrix is as follows:

$$U = {\hat{W} ( I - B )}^{- 1} ;$$

where U denotes a matrix, where the element

$${u}_{m , i}^{n , j}$$

denotes an amount of water scarcity risk implied by the transmission of the sector m in the region j (donor) to the sector m in the region i(receptor);

W is a row vector, in which each element denotes the water scarcity risk of each sector in each region, and the expression ‘Ŵ’ is a process of diagonalization of the vector W.

The matrix (I−B)⁻¹ is usually called the Ghosh inverse matrix, the element

$${g}_{m , i}^{n , j}$$

denotes the output of the sector n in the region j caused by the accumulation of unit products produced by the sector m in the region i (including direct and indirect), B denotes the direct output coefficient matrix in the multi-regional input-output model, I denotes the unit matrix.

In some embodiments, based on a structural path analysis (SPA) and the hidden water scarcity risk transfer matrix, identifying the critical transmission path of the hidden water scarcity risk, and constructing the hidden water scarcity risk transmission network, the specific contents are as follows:

after a Taylor expansion of the Ghosh inverse matrix, the hidden water scarcity risk is decomposed into different production levels:

$$G = {( I - B )}^{- 1} = I + B + {B}^{2} + {B}^{3} + … ;$$

$$U = \hat{W} ( I + B + {B}^{2} + {B}^{3} + … ) = \hat{W} I + \hat{W} B + \hat{W} {B}^{2} + \hat{W} {B}^{3} + … ;$$

assuming that a specific supply chain path starts from the sector m in the region i, passes through the sector k (r₁, r₂, . . . rₖ), and ends in the sector q in the region, the amount of hidden water scarcity risk transmitted by the path can be mathematically expressed as follows:

$${EWSR}_{SPA} = P ( m , q \vert {r}_{1} , {r}_{2} , … {r}_{k} ) = {W}_{m , i} {b}_{{mr}_{1}} {b}_{{r}_{1} {r}_{2}} … {b}_{{r}_{k} q} ;$$

where EWSR_{SPA} denotes the hidden water scarcity risk transmitted through this path; P(m,q|r₁, r₂, . . . rₖ) denotes the weight of the supply chain path (m→r₁→r₂→ . . . →rₖ→q);

W_{m,i} denotes the water scarcity risk of the sector m in the region i;

the element bₘᵣ_{₁}bᵣ_{₁}ᵣ_{₂} . . . bᵣ_{ₖ}_{q} is an element in matrix B;

by comparing the value of EWSR_{SPA} of each path, the critical transmission path of the hidden water scarcity risk is determined;

the hidden water scarcity risk transmission network is composed of supply chain paths.

In some embodiments, the specific content of identifying the critical intermediate nodes in the hidden water scarcity risk transmission network based on the betweenness centrality algorithm Betweenness is as follows:

$${b}_{i} = {\sum }_{m = 1}^{n} {\sum }_{q = 1}^{n} {\sum }_{k = 1}^{∞} ( {t}_{k} P ( m , q \vert {r}_{1} , {r}_{2} , … {r}_{k} ) )$$

where bᵢ denotes a betweenness centrality Betweenness of an intermediary centrality in the sector i;

n denotes the number of sectors in the transmission network with hidden water scarcity risk;

tₖ denotes an occurrence time of the sector i between the two ends of the supply chain path (m→r₁→r₂→ . . . →rₖ→q).

A total weight of the supply chain path through the sector i is defined as bᵢ(l₁,l₂).

$$\begin{matrix}{b}_{i} ( {l}_{i} , {l}_{2} ) = \text{?} ( {W}_{{r}_{1}} {b}_{{r}_{1} {r}_{2}} … \text{?} … \text{?} ) \\ = \text{?} ( {W}_{{r}_{1}} {b}_{{r}_{1} {r}_{2}} … \text{?} ( \text{?} … \text{?} ) ) \\ = ( \text{?} ( {W}_{{r}_{1}} {b}_{{r}_{1} {r}_{2}} … \text{?} ) ) ( \text{?} ( \text{?} … \text{?} ) ) \\ = {( W \text{?} )}_{i} {( {B}^{{l}_{2}} e )}_{i} \\ = {WB}^{{l}_{1}} {J}_{i} {B}^{{l}_{2}} e\end{matrix}$$

$$\text{?} \text{indicates text missing or illegible when filed}$$

where l₁ denotes the number of upstream sectors of the sector i, l₂ denotes the number of downstream sectors of the sector i; l₁ and l₂ are all integers greater than or equal to 1;

Jᵢ denotes a matrix that is 1 at the element (i,i) and other elements are zero;

e denotes a unit column vector with a size of n×1, all elements are equal to 1;

defining T=GB=BG=B+B²+B³+ . . . , the betweenness of the sector i may be written as

$$\begin{matrix}{b}_{i} = {\sum }_{{l}_{1} = 1}^{∞} {\sum }_{{l}_{2} = 1}^{∞} {b}_{i} ( {l}_{1} , {l}_{2} ) = {\sum }_{{l}_{1} = 1}^{∞} {\sum }_{{l}_{2} = 1}^{∞} ( {WB}^{{l}_{1}} {J}_{i} {B}^{{l}_{2}} e ) \\ = {\sum }_{{l}_{1} = 1}^{∞} ( {WB}^{{l}_{i}} {J}_{i} {\sum }_{{l}_{2} = 1}^{∞} ( {B}^{{l}_{2}} e ) ) \\ = ( {\sum }_{{l}_{1} = 1}^{∞} ( W \text{?} ) ) {J}_{i} ( {\sum }_{{l}_{2} = 1}^{∞} ( {B}^{{l}_{2}} e ) ) \\ = W ( {\sum }_{{l}_{1} = 1}^{∞} \text{?} ) {J}_{i} ( {\sum }_{{l}_{2} = 1}^{∞} \text{?} ) e \\ = {WTJ}_{i} Te\end{matrix}$$

$$\text{?} \text{indicates text missing or illegible when filed}$$

where the n×n matrix T=GB is composed of a Ghosh inverse matrix G and a direct output coefficient matrix B, the element tᵢⱼ in the matrix denotes direct and indirect outputs of the sector j generated by a single output of the sector i;

by comparing the betweenness centrality value bᵢ of each regional sector, the critical intermediate nodes in the hidden water scarcity risk transmission network are determined.

A critical path and intermediate node identification system of the hidden water scarcity risk transmission based on the betweenness centrality algorithm, including:

Data acquisition unit, configured to obtain a probability of water scarcity in each region, obtain the water scarcity risk of each sector in each region based on the water resource dependence of each sector in each region, and the probability of water scarcity in each region;

matrix calculation unit, configured to calculate the hidden water scarcity risk transfer matrix according to the water scarcity risk of each sector and based on the multi-regional input-output model;

path identification unit, configured to identify the critical transmission path of the hidden water scarcity risk and construct the hidden water scarcity risk transmission network based on the structural path analysis (SPA) and the hidden water scarcity risk transfer matrix;

intermediate node identification unit, configured to identify the critical intermediate nodes in the hidden water scarcity risk transmission network based on the betweenness centrality algorithm Betweenness.

In some embodiments, an electronic device, including a memory and a processor, when the processor executes the computer program, the steps of the critical path and intermediate node identification method of the hidden water scarcity risk transmission based on an intermediary centrality algorithm are realized.

Meanwhile, in order to solve the above technical problems, the present disclosure also provides a storage medium.

In some embodiments, a computer readable storage medium, the computer readable storage medium stores computer programs; when the computer program is executed by the processor, the steps of the critical path and intermediate node identification method for the hidden water scarcity risk transmission based on the betweenness centrality algorithm are realized.

In summary, the present disclosure is a critical path and intermediate node identification method of the hidden water scarcity risk transmission based on the betweenness centrality algorithm. Compared with the traditional technology, the present disclosure introduces the monetization index of water scarcity risk and calculates the hidden water scarcity risk transfer matrix in combination with the input-output model. Through structural path analysis, SPA identifies the critical supply chain path of the hidden water scarcity risk transmission, and constructs the hidden water scarcity risk transmission network.

Finally, the critical intermediate nodes in the hidden water scarcity risk transmission network are identified based on the betweenness centrality algorithm Betweenness. By identifying the critical supply chain paths and intermediate nodes of the hidden water scarcity risk transmission, it can not only effectively avoid the supply chain disruption caused by water scarcity, but also help to prevent the hidden water scarcity risk of a certain node from spreading to the outside, thus improving the stability of the supply chain and the resilience of the trade network.

The following is a further detailed description of the technical method of the present disclosure through drawings and implementation examples.

### BRIEF DESCRIPTION OF THE DRAWINGS

FIG. 1 is a step diagram of the critical path and intermediate node identification method of the hidden water scarcity risk transmission based on the betweenness centrality algorithm.

FIG. 2 is a unit diagram of the intermediate node identification unit of the critical path and intermediate node identification method of the hidden water scarcity risk transmission based on the betweenness centrality algorithm.

### DETAILED DESCRIPTION OF THE EMBODIMENTS

The following is a further explanation of the technical method of the present disclosure through drawings and implementation examples. It should be noted that unless otherwise specified, the relative arrangement, numerical expressions, and values of the components and steps described in these embodiments do not limit the scope of this application.

The following description of at least one exemplary embodiment is actually only illustrative and in no way serves as any restriction on the application and its application or use.

The technology, systems, and equipment known to the general technical staff in the relevant field may not be discussed in detail, but in appropriate cases, the technology, systems, and equipment should be considered as part of the specification.

In all the examples shown and discussed here, any specific value should be interpreted as merely illustrative, not as a restriction. Therefore, other examples of exemplary embodiments can have different values.

Unless otherwise defined, the technical terms or scientific terms used in the present disclosure should be understood by people with general skills in the field to which the present disclosure belongs.

The present disclosure shows significant advantages in water scarcity risk assessment and management compared with existing technologies. In the present disclosure, the water scarcity risk will not only lead to direct economic losses in water-intensive sectors such as local agriculture and power generation, but also spread the risk to other regions through the supply chain, resulting in the hidden water scarcity risk based on the transmission of trade links.

By comprehensively identifying all the critical supply chain paths and intermediate nodes of the hidden water scarcity risk in the transmission process, the present disclosure can help prevent the supply chain disruption caused by water scarcity and the hidden water scarcity risk of a certain node from spreading to the outside, thereby avoiding the generation of systemic risks. This measure not only addresses the important challenges in current water resources management, but also provides a practical solution for improving the stability of the supply chain and the resilience of the trade network.

### Example 1

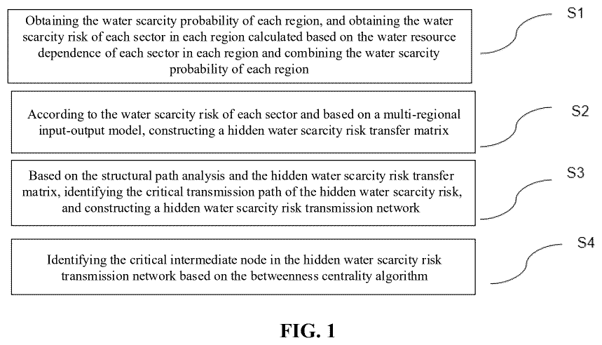

As shown in FIG. 1, the present disclosure provides a critical path and intermediate node identification method of the hidden water scarcity risk transmission based on the betweenness centrality algorithm, including the following steps:

S1, the water scarcity probability of each region is obtained, and the water scarcity risk of each sector in each region is obtained, which is calculated based on the water resource dependence of each sector in each region and combining the water scarcity probability of each region;

In some embodiments, the expression of water scarcity probability in each region is as follows:

$${WSP}_{i} = exp ( {μ}_{{w}_{i}} + \frac{{σ}^{2}}{2} ) ;$$

$${w}_{i} ∼ ( {μ}_{{w}_{i}} , {σ}^{2} ) ;$$

where WSPᵢ denotes the water scarcity probability of the region i is equal to an expected value of a random variable wᵢ; the random variable wᵢ obeys the lognormal distribution, the variance is

$${μ}_{i} = log \frac{1}{{WSI}_{i}} ,$$

σ denotes the standard deviation and is equal to 1;

$${WSI}_{i} = \frac{{WC}_{i}}{{Q}_{i}} ,$$

WSIᵢ denotes the water pressure index of the region i, WCᵢ denotes the water consumption of the region i, and Qᵢ denotes the available freshwater volume of the region i.

In some embodiments, the expression of water resource dependence of each sector in each region is as follows:

$${WD}_{m , i} = {f}_{WD} ( {WI}_{m , i} ; α ) = \frac{1}{1 + {e}^{- α {WI}_{m , i}^{i n t}} ( \frac{1}{0.001} - 1 )} ;$$

$${WI}_{m , i} = \frac{{WC}_{m , i}}{{x}_{m , i}} ;$$

where WD_{m,i} denotes the water resource dependence of the sector m in the region i; WC_{m,i} denotes the amount of water used by the sector m in the region i; WI_{m,i} denotes a water intensity of the sector m in the region i, it equals to the water consumption WC_{m,i} of the sector in the region divided by its total output x_{m,i}; α is the truncation parameter, which is set to 0.5.

$${WSR}_{m , i} = {WSP}_{i} \times {WD}_{m , i} \times {x}_{m , i} ;$$

where WSR_{m,i} denotes the water scarcity risk in the sector m in the region i; WSPᵢ denotes the probability of water scarcity in the region i; WD_{m,i} denotes the water resource dependence of the sector m in the region i; x_{m,i} denotes the total output of the sector n in the region j.

S2, according to the water scarcity risk of each sector and based on a multi-regional input-output model, the hidden water scarcity risk transfer matrix is constructed.

In some embodiments, the expression of the hidden water scarcity risk transfer matrix is as follows:

$$U = {\hat{W} ( I - B )}^{- 1} ;$$

where U denotes a matrix, where the element

$${u}_{m , i}^{n , j}$$

denotes the amount of water scarcity risk implied by the transmission of the sector m in the region j (donor) to the sector m in the region i(receptor);

W is a row vector, in which each element denotes the water scarcity risk of each sector in each region, and the expression ‘Ŵ’ is the process of diagonalization of the vector W;

the matrix (I−B)⁻¹ is usually called the Ghosh inverse matrix, the element

$${g}_{m , i}^{n , j}$$

denotes the output of the sector n in the region j caused by the accumulation of unit products produced by the sector m in the region i (including direct and indirect), B denotes the direct output coefficient matrix in the multi-regional input-output model, I denotes the unit matrix.

S3, based on the structural path analysis (SPA) and the hidden water scarcity risk transfer matrix, the critical transmission path of the hidden water scarcity risk is identified, and the hidden water scarcity risk transmission network is constructed;

In some embodiments, based on a structural path analysis (SPA) and the hidden water scarcity risk transfer matrix, identifying the critical transmission path of the hidden water scarcity risk, and constructing the hidden water scarcity risk transmission network, the specific contents are as follows:

after the Taylor expansion of the Ghosh inverse matrix, the hidden water scarcity risk is decomposed into different production levels:

$$G = {( I - B )}^{- 1} = I + B + {B}^{2} + {B}^{3} + … ;$$

$$U = ( I + B + {B}^{2} + {B}^{3} + … ) = \hat{W} I + \hat{W} B + \hat{W} {B}^{2} + \hat{W} {B}^{3} + … ;$$

assuming that a specific supply chain path starts from the sector m in the region i, passes through the sector k (r₁, r₂, . . . rₖ), and ends in the sector q in the region, the amount of hidden water scarcity risk transmitted by the path can be mathematically expressed as follows:

$${EWSR}_{SPA} = P ( m , q \vert {r}_{1} , {r}_{2} , … {r}_{k} ) = {W}_{m , i} {b}_{{mr}_{1}} {b}_{{r}_{1} {r}_{2}} … {b}_{{r}_{k} q} ;$$

where EWSR_{SPA} denotes the hidden water scarcity risk transmitted through this path; P(m,q|r₁, r₂, . . . rₖ) denotes the weight of the supply chain path (m→r₁→r₂→ . . . →rₖ→q);

W_{m,i} denotes the water scarcity risk of the sector m in the region i;

the element bₘᵣ_{₁}bᵣ_{₁}ᵣ_{₂} . . . bᵣ_{ₖ}_{q} is an element in matrix B;

by comparing the value of EWSR_{SPA} of each path, the critical transmission path of the hidden water scarcity risk is determined;

the hidden water scarcity risk transmission network is composed of supply chain paths.

S4, the critical intermediate node in the hidden water scarcity risk transmission network based on a betweenness centrality algorithm Betweenness is identified.

In some embodiments, the specific content of identifying the critical intermediate nodes in the hidden water scarcity risk transmission network based on the betweenness centrality algorithm Betweenness is as follows:

$${b}_{\dot{i}} = {\sum }_{m = 1}^{n} {\sum }_{q = 1}^{n} {\sum }_{k = 1}^{∞} ( {t}_{k} P ( m , q \vert {r}_{1} , {r}_{2} , … {r}_{k} ) )$$

where bᵢ denotes the betweenness centrality Betweenness of the intermediary centrality in the sector i;

n denotes the number of sectors in the transmission network with hidden water scarcity risk;

tₖ denotes an occurrence time of the sector i between the two ends of the supply chain path (m→r₁→r₂→ . . . →rₖ→q).

The total weight of the supply chain path through the sector i is defined as bᵢ(l₁,l₂):

$$\begin{matrix}{b}_{i} ( {l}_{1} , {l}_{2} ) = \text{?} ( {W}_{{r}_{1}} {b}_{{r}_{1} {r}_{2}} … \text{?} … \text{?} ) \\ = \text{?} ( {W}_{{r}_{1}} {b}_{{r}_{1} {r}_{2}} … \text{?} ( \text{?} … \text{?} ) ) \\ = ( \text{?} ( {W}_{{r}_{1}} {b}_{{r}_{1} {r}_{2}} … \text{?} ) ) ( \text{?} ( \text{?} … \text{?} ) ) \\ = {( W \text{?} )}_{i} {( {b}^{{l}_{2}} e )}_{i} \\ = W \text{?} {J}_{i} {B}^{{l}_{2}} e\end{matrix}$$

$$\text{?} \text{indicates text missing or illegible when filed}$$

where l₁ denotes the number of upstream sectors of the sector i, l₂ denotes the number of downstream sectors of the sector i; l₁ and l₂ are all integers greater than or equal to 1;

Jᵢ denotes a matrix that is 1 at the element (i,i) and other elements are zero;

e denotes a unit column vector with a size of n×1, all elements are equal to 1;

defining T=GB=BG=B+B²+B³+ . . . , the betweenness of the sector i may be written as:

$$\begin{matrix}{b}_{i} = {\sum }_{{l}_{1} = 1}^{∞} {\sum }_{{l}_{2} = 1}^{∞} {b}_{i} ( {l}_{1} , {l}_{2} ) = {\sum }_{{l}_{1} = 1}^{∞} {\sum }_{{l}_{2} = 1}^{∞} ( {WB}^{{l}_{1}} {J}_{i} {B}^{{l}_{2}} e ) \\ = {\sum }_{{l}_{1} = 1}^{∞} ( W \text{?} {J}_{i} {\sum }_{{l}_{2} = 1}^{∞} ( {B}^{{l}_{2}} e ) ) \\ = ( {\sum }_{{l}_{1} = 1}^{∞} ( {WB}^{{l}_{1}} ) ) {J}_{i} ( {\sum }_{{l}_{2} = 1}^{∞} ( {B}^{{l}_{2}} e ) ) \\ = W ( {\sum }_{{l}_{1} = 1}^{∞} {B}^{{l}_{1}} ) {J}_{i} ( {\sum }_{{l}_{2} = 1}^{∞} {B}^{{l}_{2}} ) e \\ = {WTJ}_{i} Te\end{matrix}$$

$$\text{?} \text{indicates text missing or illegible when filed}$$

where the n×n matrix T=GB is composed of a Ghosh inverse matrix G and a direct output coefficient matrix B, the element tᵢⱼ in the matrix denotes direct and indirect outputs of the sector j generated by a single output of the sector i;

by comparing the betweenness centrality value bᵢ of each regional sector, the critical intermediate nodes in the hidden water scarcity risk transmission network are determined.

### Example 2

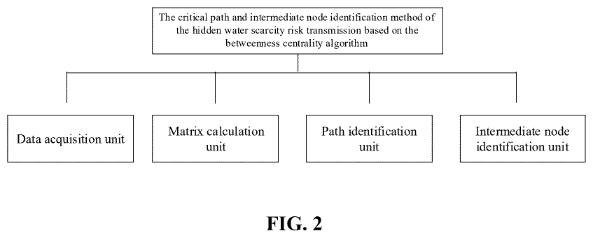

As shown in FIG. 2, a critical path and intermediate node identification system of the hidden water scarcity risk transmission based on the betweenness centrality algorithm includes:

Data acquisition unit, configured to obtain a probability of water scarcity in each region, obtain the water scarcity risk of each sector in each region based on the water resource dependence of each sector in each region and the probability of water scarcity in each region;

matrix calculation unit, configured to calculate the hidden water scarcity risk transfer matrix according to the water scarcity risk of each sector and based on the multi-regional input-output model;

path identification unit, configured to identify the critical transmission path of the hidden water scarcity risk and construct the hidden water scarcity risk transmission network based on the structural path analysis (SPA) and the hidden water scarcity risk transfer matrix;

intermediate node identification unit, configured to identify the critical intermediate nodes in the hidden water scarcity risk transmission network based on the betweenness centrality algorithm Betweenness.

### Example 3

An electronic device, including a memory and a processor, when the processor executes the computer program, the steps of the critical path and intermediate node identification method of the hidden water scarcity risk transmission based on an intermediary centrality algorithm are realized.

### Example 4

A computer readable storage medium, the computer readable storage medium stores computer programs; when the computer program is executed by the processor, the steps of the critical path and intermediate node identification method of the hidden water scarcity risk transmission based on the betweenness centrality algorithm are realized

### Example 5

This example takes China's provinces and cities as the research object, covering 31 provinces and cities (excluding Taiwan, Macao, and Hong Kong). Based on the input-output table data of 2017, each province and city contains 42 industrial sectors. As of the latest data in 2017, the critical path and intermediate node identification method of the hidden water scarcity risk transmission described in Example 1 is adopted. According to the algorithms and formulas specified in each step, the critical path and intermediate node of the hidden water scarcity risk transmission are identified. The results are as follows:

Five regional sectors with the highest water scarcity risk are as follows: Hebei-agriculture, forestry, animal husbandry, and fishery service industry (101.6 billion yuan), Jiangsu-textile industry (97.8 billion yuan), Shaanxi-non-metallic mineral and other mineral mining and processing industry (71.2 billion yuan), Shanghai-chemical industry (70.9 billion yuan), and Beijing-food manufacturing industry (59.7 billion yuan).

The critical supply chain paths of the hidden water scarcity risk transmission: Shanghai-Chemical Industry Zhejiang-General Equipment Manufacturing Industry (2.1 billion yuan), Jiangsu-Chemical Industry Shandong-Food Manufacturing Industry (1.8 billion yuan), Henan-Agriculture, Forestry, Animal Husbandry and Fishery Service Guangdong-General Equipment Manufacturing Industry (1.6 billion yuan), Anhui-Metal Products, Machinery and Equipment Repair Service Guangdong-Information Transmission, Software and Information Technology Services (1.5 billion yuan), Beijing-Paper Printing and Cultural and Educational Sports Goods Manufacturing Industry Liaoning-Waste Waste (1.1 billion yuan).

The critical intermediate nodes of the hidden water scarcity risk transmission are Shanghai-chemical industry (99.7 billion yuan), Hebei-food manufacturing industry (91.5 billion yuan), Guangdong-communication equipment, computer and other electronic equipment manufacturing industry (86.4 billion yuan), Shaanxi-metal products industry (80.9 billion yuan), Zhejiang-general equipment manufacturing industry (75.5 billion yuan).

The water scarcity risk value in brackets in the above results is the relative value, rather than the actual economic loss amount. These relative values reflect the relative amount of potential economic losses. By comparing these values, the critical supply chain paths and intermediate nodes that imply water scarcity risk transmission can be identified.

The above results reveal that the local water scarcity risk will cause potential indirect economic losses to external regional sectors through the trade network, and clarify the critical supply chain path and intermediate nodes of the hidden water scarcity risk transmission, which lays a foundation for a systematic and comprehensive assessment of the impact of water scarcity risk on the economy. This analysis provides data support for the development of more effective coping strategies, thereby enhancing the resilience of the entire trade network in dealing with the hidden water scarcity risk. The significance of identifying the critical intermediate nodes is to help us intervene in risk transmission promptly, thereby preventing potential serious consequences.

Specifically, for the regional sectors on the critical supply chain path that implies water scarcity risk transmission, each regional sector should take active measures to reduce the risk impact: Firstly, the trade strategy is adjusted and the industrial structure is optimized to reduce dependence on specific suppliers. Secondly, the establishment of an inter-regional cooperation mechanism, through the sharing of resources and technology, enhances the ability to cope with the hidden water scarcity risk. Finally, the monitoring and evaluation system is strengthened to identify potential risks in time and formulate corresponding emergency plans to ensure that risks can be dealt with quickly and effectively. For the critical intermediate nodes in the hidden water scarcity risk transmission network, regional sectors can take the following measures: Firstly, the utilization efficiency and management level of water resources are improved to ensure a stable supply when demand fluctuates. Secondly, enterprises are encouraged to diversify their supply sources to reduce their dependence on any single upstream sector or input, thereby enhancing the resilience of the system. In addition, strengthen cooperation with critical supply chain intermediate nodes, use information sharing platforms and technical means to improve the ability to respond to water scarcity events, in order to achieve more efficient risk management.

Finally, it should be explained that the above embodiments are only used to illustrate the technical method of the present disclosure rather than restrict it. Although the present disclosure is described in detail with reference to the better embodiment, the ordinary technical personnel in this field should understand that they can still modify or replace the technical method of the present disclosure, and these modifications or equivalent substitutions cannot make the modified technical method out of the spirit and scope of the technical method of the present disclosure.

What is claimed is:

1. A method of reducing regional water scarcity risk, comprising the following steps:
S1, obtaining a water scarcity probability of each region, and obtaining a water scarcity risk of each sector in each region calculated based on a water resource dependence of each sector in each region and combining the water scarcity probability of each region;
S2, according to the water scarcity risk of each sector and based on a multi-regional input-output model, constructing a hidden water scarcity risk transfer matrix;
S3, based on a structural path analysis and the hidden water scarcity risk transfer matrix, identifying a critical transmission path of the hidden water scarcity risk, and constructing a hidden water scarcity risk transmission network;
S4, identifying a critical intermediate node in the hidden water scarcity risk transmission network based on a betweenness centrality algorithm;
wherein the expression of water scarcity probability in each region is as follows:
$${WSP}_{i} = exp ( {μ}_{{w}_{i}} + \frac{{σ}^{2}}{2} ) ;$$
$${w}_{i} ∼ ( {μ}_{{w}_{i}} , {σ}^{2} ) ;$$
where WSPᵢ denotes a water scarcity probability of a region i is equal to an expected value of a random variable wᵢ; the random variable wᵢ obeys a lognormal distribution, the variance is
$${μ}_{i} = log \frac{1}{{WSI}_{i}} ,$$
σ denotes a standard deviation and is equal to 1;
$${WSI}_{i} = \frac{{WC}_{i}}{{Q}_{i}} ,$$
WSIᵢ denotes a water pressure index of the region i, WCᵢ denotes a water consumption of the region i, and Qᵢ denotes an available freshwater volume of the region i;
wherein the expression of water resource dependence of each sector in each region is as follows:
$${WD}_{m , i} = {f}_{WD} ( {WI}_{m , i} ; α ) = \frac{1}{1 + {e}^{- α {WI}_{m , i}^{i n t}} ( \frac{1}{0.001} - 1 )} ,$$
$${WI}_{m , i} = \frac{{WC}_{m , i}}{{x}_{m , i}} ;$$
where WD_{m,i} denotes a water resource dependence of a sector m in the region i; WC_{m,i} denotes the amount of water used by the sector m in the region i; WI_{m,i} denotes a water intensity of the sector m in the region i, it equals to the water consumption WC_{m,i} of the sector in the region divided by its total output x_{m,i}; α is the truncation parameter, which is set to 0.5.

2. The method of reducing water scarcity risk according to claim 1, wherein the expression of water scarcity risk of each sector in each region is as follows:
$${WSR}_{m , i} = {WSP}_{i} {WD}_{m , i} \times {x}_{m , i} ;$$
where WSR_{m,i} denotes a water scarcity risk in the sector m in the region i; WSPᵢ denotes a probability of water scarcity in the region i; WD_{m,i} denotes a water resource dependence of the sector m in the region i; and x_{m,i} denotes a total output of the sector n in the region j.

3. The method of reducing water scarcity risk according to claim 2, wherein the expression of the hidden water scarcity risk transfer matrix is as follows:
$$U = {\hat{W} ( I - B )}^{- 1} ;$$
where U denotes a matrix, where the element
$${u}_{m , i}^{n , j}$$
denotes an amount of water scarcity risk implied by the transmission of the sector m in the region j to the sector m in the region i;
W is a row vector, in which each element denotes the water scarcity risk of each sector in each region, and the expression ‘Ŵ’ is a process of diagonalization of the vector W;
the matrix (I−B)⁻¹ is called the Ghosh inverse matrix, the element
$${g}_{m , i}^{n , j}$$
denotes an output of the sector n in the region j caused by the accumulation of unit products produced by the sector m in the region i, B denotes a direct output coefficient matrix in the multi-regional input-output model, I denotes the unit matrix.

4. The method of reducing water scarcity risk according to claim 3, wherein based on a structural path analysis and the hidden water scarcity risk transfer matrix, identifying the critical transmission path of the hidden water scarcity risk, and constructing the hidden water scarcity risk transmission network, the specific contents are as follows:
after a Taylor expansion of the Ghosh inverse matrix, the hidden water scarcity risk is decomposed into different production levels:
$$G = {( I - B )}^{- 1} = I + B + {B}^{2} + {B}^{3} + … ;$$
$$U = \hat{W} ( I + B + {B}^{2} + {B}^{3} + … ) = \hat{W} I + \hat{W} B + \hat{W} {B}^{2} + \hat{W} {B}^{3} + … ;$$
assuming that a specific supply chain path starts from the sector m in the region i, passes through the sector k (r₁, r₂, . . . rₖ), and ends in the sector q in the region, the amount of hidden water scarcity risk transmitted by the path can be mathematically expressed as follows:
$${EWSR}_{SPA} = P ( m , q \vert {r}_{1} , {r}_{2} , … {r}_{k} ) = {W}_{m , i} {b}_{{mr}_{1}} {b}_{{r}_{1} {r}_{2}} … {b}_{{r}_{k} q} ;$$
where EWSR_{SPA} denotes a hidden water scarcity risk transmitted through this path; P(m,q|r₁, r₂, . . . rₖ) denotes the weight of the supply chain path (m→r₁→r₂→ . . . →rₖ→q);
W_{m,i} denotes the water scarcity risk of the sector m in the region i;
the element bₘᵣ_{₁}bᵣ_{₁}ᵣ_{₂} . . . bᵣ_{ₖ}_{q} is an element in matrix B;
by comparing the value of EWSR_{SPA} of each path, the critical transmission path of the hidden water scarcity risk is determined;
the hidden water scarcity risk transmission network is composed of supply chain paths.

5. The method of reducing water scarcity risk according to claim 4, wherein the specific content of identifying the critical intermediate nodes in the hidden water scarcity risk transmission network based on the betweenness centrality algorithm is as follows:
$${b}_{i} = {\sum }_{m = 1}^{n} {\sum }_{q = 1}^{n} {\sum }_{k = 1}^{∞} ( {t}_{k} P ( m , q \vert {r}_{1} , {r}_{2} , … {r}_{k} ) )$$
where bᵢ denotes a betweenness centrality of an intermediary centrality in the sector i;
n denotes the number of sectors in the transmission network with hidden water scarcity risk;
tₖ denotes an occurrence time of the sector i between the two ends of the supply chain path (m→r₁→r₂→ . . . →rₖ→q);
a total weight of the supply chain path through the sector i is defined as bᵢ(l₁,l₂):
$$\begin{matrix}{b}_{i} ( {l}_{1} , {l}_{2} ) = \text{?} ( {W}_{{r}_{1}} {b}_{{r}_{1} {r}_{2}} … \text{?} … \text{?} ) \\ = \text{?} ( {W}_{{r}_{1}} {b}_{{r}_{1} {r}_{2}} … \text{?} ( \text{?} … \text{?} ) ) \\ = ( \text{?} ( {W}_{{r}_{1}} \text{?} … \text{?} ) ) ( \text{?} ( \text{?} … \text{?} ) ) \\ = {( W \text{?} )}_{i} {( \text{?} e )}_{i} \\ = W \text{?} {J}_{i} \text{?} e\end{matrix}$$
$$\text{?} \text{indicates text missing or illegible when filed}$$
where l₁ denotes the number of upstream sectors of the sector i, l₂ denotes the number of downstream sectors of the sector i; l₁ and l₂ are all integers greater than or equal to 1;
Jᵢ denotes a matrix that is 1 at the element (i,i) and other elements are zero;
e denotes a unit column vector with a size of n×1, all elements are equal to 1;
defining T=GB=BG=B+B²+B³+ . . . , the betweenness of the sector i may be written as:
$$\begin{matrix}{b}_{i} = \text{?} {b}_{i} ( {l}_{1} , {l}_{2} ) = \text{?} ( {WB}^{{l}_{1}} {J}_{i} {B}^{{l}_{2}} e ) \\ = \text{?} ( W \text{?} {J}_{i} {\sum }_{{l}_{2} = 1}^{∞} ( {B}^{{l}_{2}} e ) ) \\ = ( \text{?} ( W \text{?} ) ) {J}_{i} ( \text{?} ( {B}^{{l}_{2}} e ) ) \\ = W ( \text{?} ) {J}_{i} ( \text{?} ) e \\ = {WTJ}_{i} Te\end{matrix}$$
$$\text{?} \text{indicates text missing or illegible when filed}$$
where the n×n matrix T=GB is composed of a Ghosh inverse matrix G and a direct output coefficient matrix B, the element tᵢⱼ in the matrix denotes direct and indirect outputs of the sector j generated by a single output of the sector i;
by comparing the betweenness centrality value bᵢ of each regional sector, the critical intermediate nodes in the hidden water scarcity risk transmission network are determined.

6. A method of reducing water scarcity risk, comprising:
data acquisition unit, configured to obtain a probability of water scarcity in each region, obtain the water scarcity risk of each sector in each region based on the water resource dependence of each sector in each region and the probability of water scarcity in each region;
wherein the expression of water scarcity probability in each region is as follows:
$${WSP}_{i} = exp ( {μ}_{{w}_{i}} + \frac{{σ}^{2}}{2} ) ;$$
$${w}_{i} ∼ ( {μ}_{{w}_{i}} , {σ}^{2} ) ;$$
where WSPᵢ denotes a water scarcity probability of a region i is equal to an expected value of a random variable wᵢ; the random variable wᵢ obeys a lognormal distribution, the variance is
$${μ}_{i} = log \frac{1}{{WSI}_{i}} ,$$
σ denotes a standard deviation and is equal to 1;
$${WSI}_{i} = \frac{{WC}_{i}}{{Q}_{i}} ,$$
WSIᵢ denotes a water pressure index of the region i, WCᵢ denotes a water consumption of the region i, and Qᵢ denotes an available freshwater volume of the region i;
wherein the expression of water resource dependence of each sector in each region is as follows:
$${WD}_{m , i} = {f}_{WD} ( {WI}_{m , i} ; α ) = \frac{1}{1 + {e}^{- α {WI}_{m , i}^{i n t}} ( \frac{1}{0.001} - 1 )} ;$$
$${WI}_{m , i} = \frac{{WC}_{m , i}}{{x}_{m , i}} ;$$
where WD_{m,i} denotes a water resource dependence of a sector m in the region i; WC_{m,i} denotes the amount of water used by the sector m in the region i; WI_{m,i} denotes a water intensity of the sector m in the region i, it equals to the water consumption WC_{m,i} of the sector in the region divided by its total output x_{m,i}; α is the truncation parameter, which is set to 0.5.
matrix calculation unit, configured to calculate the hidden water scarcity risk transfer matrix according to the water scarcity risk of each sector and based on the multi-regional input-output model;
path identification unit, configured to identify the critical transmission path of the hidden water scarcity risk and construct the hidden water scarcity risk transmission network based on the structural path analysis and the hidden water scarcity risk transfer matrix;
intermediate node identification unit, configured to identify the critical intermediate nodes in the hidden water scarcity risk transmission network based on the betweenness centrality algorithm.
